(19) United States
(12) Patent Application Publication
(10) Pub. No.: US 2014/0176371 A1
(43) Pub. Date: Jun. 26, 2014

(54) PORTABLE ELECTRONIC DEVICE HAVING NEAR FIELD COMMUNICATION ANTENNA

(71) Applicant: HON HAI PRECISION INDUSTRY CO., LTD., New Taipei (TW)

(72) Inventor: KUANG-YAO LIAO, New Taipei (TW)

(73) Assignee: HON HAI PRECISION INDUSTRY CO., LTD., New Taipei (TW)

(21) Appl. No.: 14/060,595

(22) Filed: Oct. 22, 2013

(30) Foreign Application Priority Data
Dec. 26, 2012 (TW) 101149954

(51) Int. Cl. H01Q 1/52; G06F 3/041

(52) U.S. Cl. CPC H01Q 1/526; G06F 3/0412
USPC 343/702

(57) ABSTRACT

A portable electronic device includes a touch screen, a first printed circuit board and an NFC antenna. The touch screen includes an effective touch area and an ineffective touch area surrounding the effective touch area. The first printed circuit board is adhered to the rear of the touch screen, and includes a first conducting layer and a second conducting layer, with the first conducting layer being sandwiched between the touch screen and the second conducting layer. The NFC antenna is disposed on a peripheral area of an opposite surface of the first conducting layer to the touch screen and is aligned with the ineffective touch area. A shielding layer is disposed on a surface of the second conducting layer and is aligned with the NFC antenna, and shields the NFC antenna from interference caused by electrical elements of the electronic device located under the first conducting layer.

### BACKGROUND

1. Technical Field

The present disclosure relates to a portable electronic device having near field communication (NFC) antenna.

2. Description of Related Art

Nowadays, application using NFC technology is very popular. Portable electronic devices having NFC module can integrate with several different applications, such as bus card, credit card, access card, bank card and membership card, which brings a great convenience to daily life. However, existing NFC antenna usually needs to occupy a larger space of a print circuit board (PCB) of the electronic device, and adjacent electronic components will interfere with the performance of the NFC antenna. With the popularization of small size portable electronic devices with large display screens and large effective touch area, the design of the NFC antennas and reduction of interference, without increasing the size of the electronic device has been problematic.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram showing three views of a portable electronic device, according to an embodiment.

FIG. 2 is an exploded view of the electronic device of FIG 1.

FIG. 3 is a schematic diagram showing two views of a first conducting layer of a first printed circuit board of the electronic device of FIG. 2.

FIG. 4 is a schematic diagram showing two views of a second conducting layer of the first printed circuit board of FIG. 3.

FIG. 5 is a schematic diagram showing two views of a second printed circuit board of the electronic device of FIG. 2.

### DETAILED DESCRIPTION

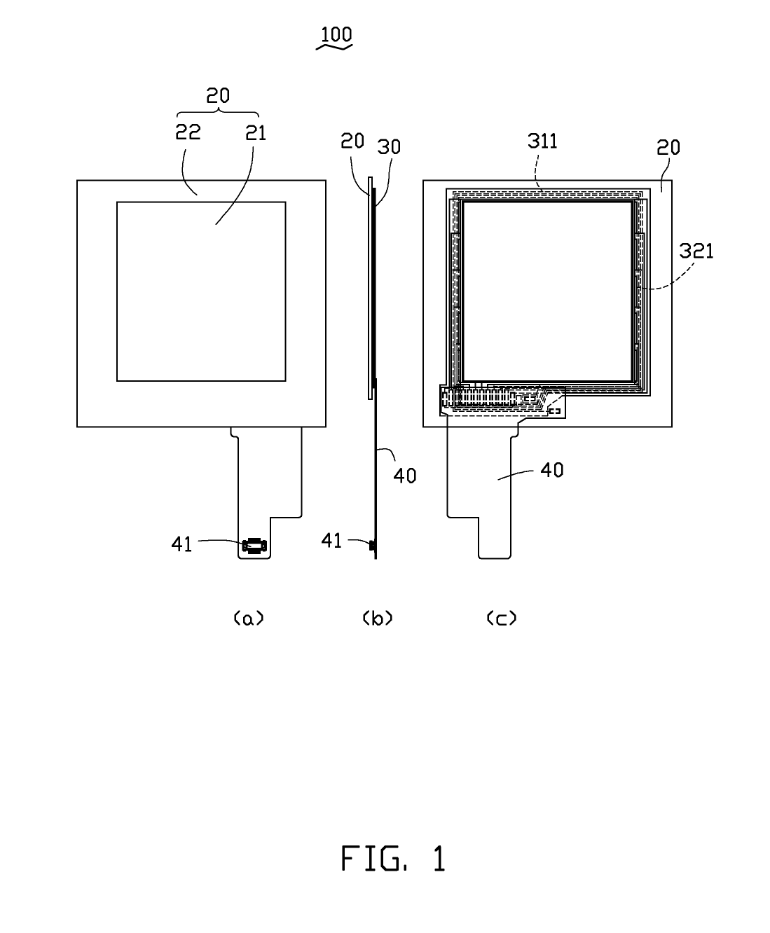

FIG. 1 shows a portable electronic device 100 of the embodiment. The electronic device 100 includes a touch screen 20, a first printed circuit board 30 and a second printed circuit board 40. The electronic device 100 may be selected from a group consisting of a smart phone and an electronic wrist watch. The touch screen 20 includes an effective touch area 21 and an ineffective touch area 22 surrounding the effective touch area 21. The effective touch area 21 is capable of receiving manual touches, and the ineffective touch area 22 is incapable of receiving touches. The first printed circuit board 30 and the second printed circuit board 40 are arranged on a rear surface of the touch screen 20.

In this embodiment, the first printed circuit board 30 is adhered to the rear surface of the touch screen 20. The electronic device 100 further includes an NFC antenna 311 and a touch sensing circuit 321 arranged on a peripheral area of the first printed circuit board 30 and aligned with the ineffective touch area 22 of the touch screen 20. In this embodiment, the material of the touch screen 20 is carbon nanotubes, resulting in reduced electrostatic interference between the touch screen 20 and the NFC antenna 311.

The second printed circuit board 40 is a flexible printed circuit board, and is connected to an opposite surface of the first printed circuit board 30 to the touch screen 20. The second printed circuit board 40 is configured to electrically connect the first printed circuit board 30 to a main circuit board (not shown) of the electronic device 100.

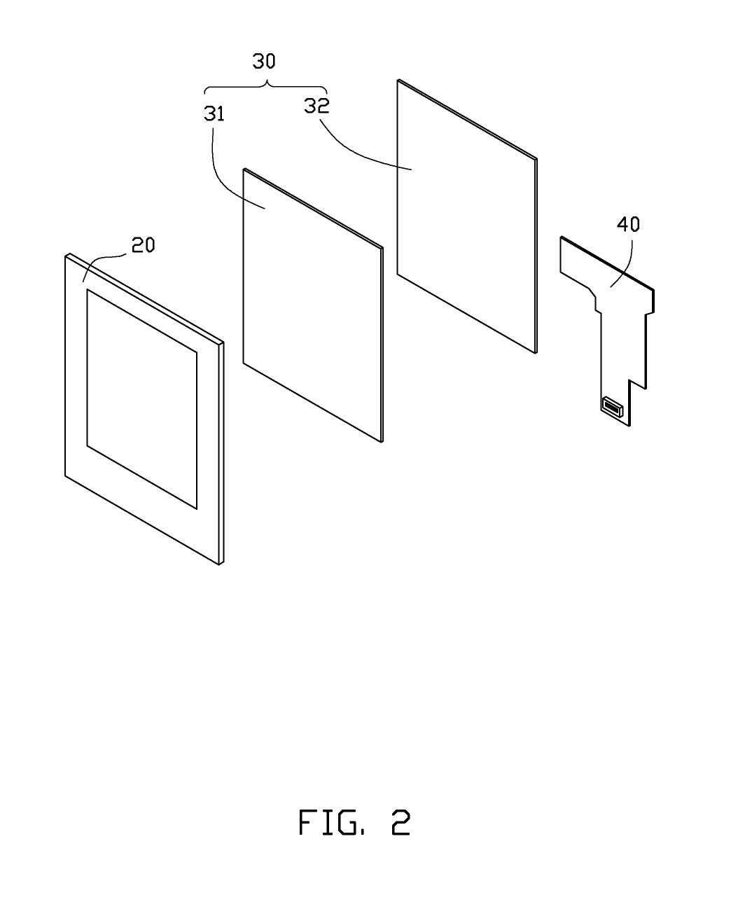

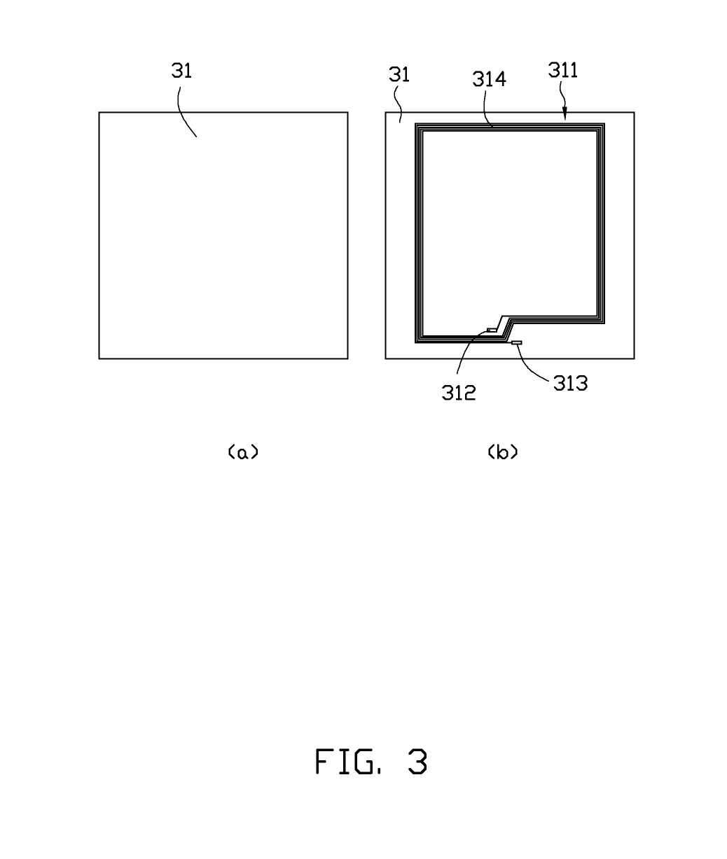

FIG. 2 shows that the first printed circuit board 30 includes a first conducting layer 31 and a second conducting layer 32. The first conducting layer 31 is sandwiched between the touch screen 20 and the second conducting layer 32. FIG. 3 shows that the NFC antenna 311 is disposed on an opposite surface of the first conducting layer 31 to the touch screen 20 and is aligned with the ineffective touch area 22 of the touch screen 20. In this embodiment, the NFC antenna 311 includes a coil 314, a first antenna connection element 312 and a second antenna connection element 313. The coil 314 follows a spiral labyrinth-type pattern and surrounds the effective touch area 21, resulting in providing enough space for the NFC antenna 311 without increasing the size of the electronic device 100 and reducing the effective touch area. In this embodiment, the NFC antenna 311 is formed to be rectangular. The first antenna connection element 312 and the second antenna connection element 313 are connected to two ends of the coil 314, respectively.

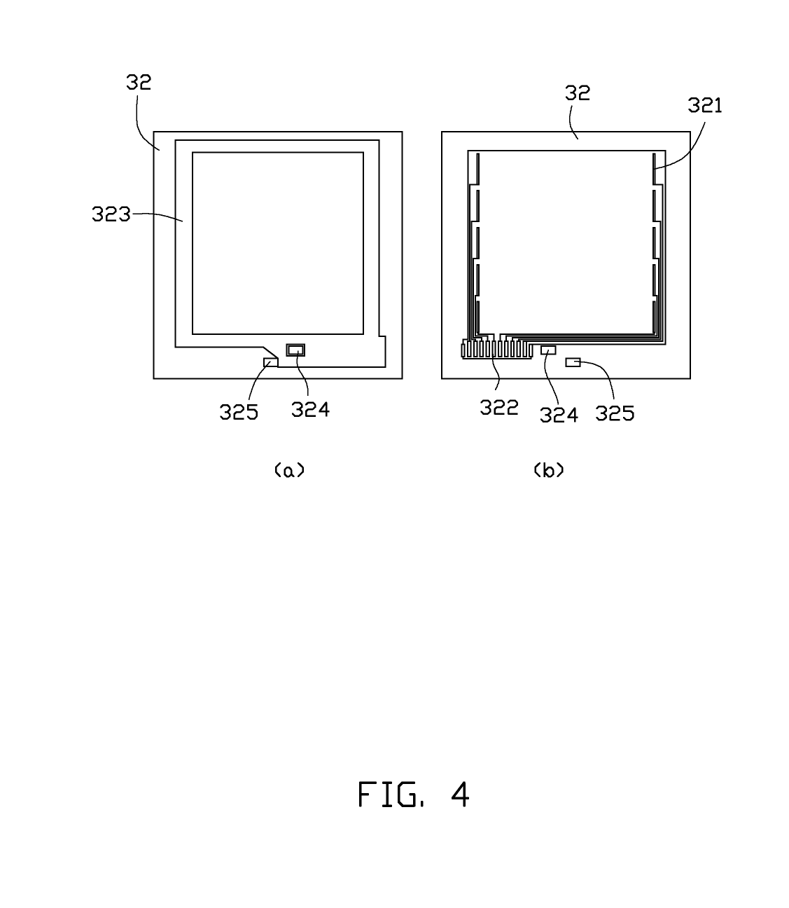

FIG. 4(a) shows that the electronic device 100 further includes a shielding layer 323 disposed on a surface of the second conducting layer 32 facing the first conducting layer 31 and aligned with the NFC antenna 311. The shielding layer 323 is configured to shield the NFC antenna 311 from interference caused by electrical elements (not shown), which are disposed on the main circuit board located under the first conducting layer 31, resulting in reduced electrostatic interference therebetween.

FIG. 4(b) shows that the touch sensing circuit 321 is printed on an opposite surface of the second conducting layer 32 to the shielding layer 323 and is aligned with ineffective touch area 22 of the touch screen 20. The touch sensing circuit 321 includes a first circuit connection element 322, which includes a number of pins.

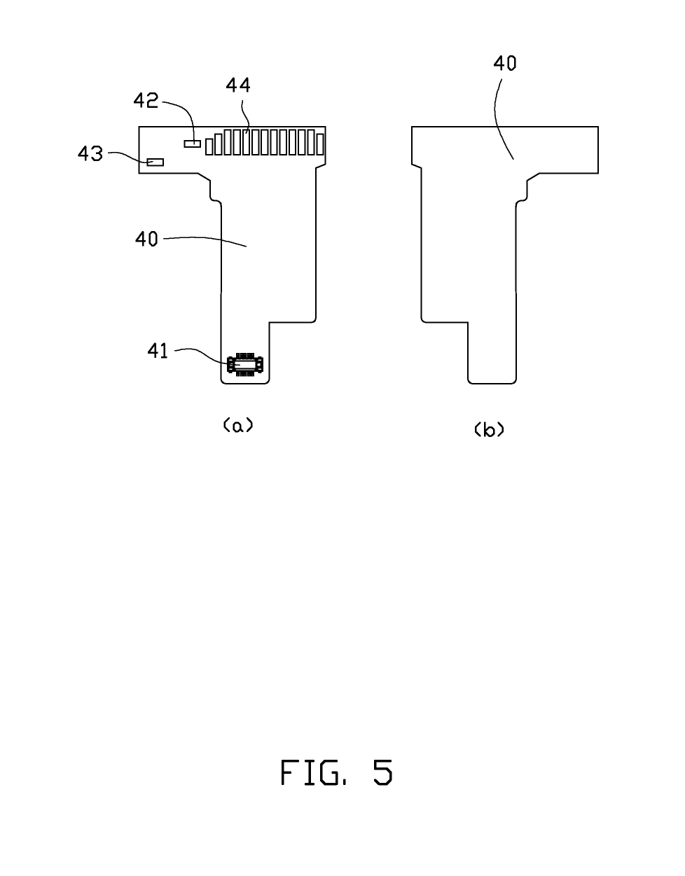

FIG. 5(a) shows that the second printed circuit board 40 includes a first antenna connection pin 42, a second antenna connection pin 43 and a second circuit connection element 44. In this embodiment, the first antenna connection pin 42 and the second antenna connection pin 43 are electrically connected to the first antenna connection element 312 and the second antenna connection element 313, correspondingly. The second circuit connection element 44 includes a number of pins electrically connected to the number of pins of the first circuit connection clement 322.

A connector 41 is disposed on the second printed circuit board 40, and is configured to electrically connect the second printed circuit board 40 to the main circuit board (not shown) of the electronic device 100. In this embodiment, the connector 41 includes a number of pins electrically connected to the first antenna connection pin 42, the second antenna connection pin 43, and each pin of the second circuit connection element 44, respectively. Therefore, the NFC antenna 311 and the touch sensing circuit 321 can be both electrically connected to the main circuit board of the electronic device 100 through the connector 41.

FIG. 4 also shows that the second conducting layer 32 defines two via-holes 324 and 325 aligned with the first antenna connection element 312 and the second antenna connection element 313, correspondingly, in order to allow the first antenna connection element 312 and the second antenna connection element 313 to be electrically connected to the first antenna connection pin 42 and the second antenna connection pin 43 via the via-holes 324 and 325, correspondingly.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A portable electronic device comprising:
a touch screen comprising an effective touch area and an ineffective touch area surrounding the effective touch area;
a first printed circuit board adhered to a rear surface of the touch screen, the first printed circuit board comprising a first conducting layer and a second conducting layer, wherein the first conducting layer is sandwiched between the touch screen and the second conducting layer;
an NFC antenna disposed on a peripheral area of an opposite surface of the first conducting layer to the touch screen and aligned with the ineffective touch area; and
a shielding layer disposed on a surface of the second conducting layer facing the first conducting layer and aligned with the NFC antenna, the shielding layer configured to shield the NFC antenna from interference caused by electrical elements of the electronic device located under the first conducting layer.

2. The electronic device as described in claim 1, wherein the NFC antenna comprises a coil following a spiral labyrinth-type pattern and surrounding the effective touch area.

3. The electronic device as described in claim 1, wherein the NFC antenna is formed to be rectangular.

4. The electronic device as described in claim 2, further comprising a second printed circuit board connected to an opposite surface of the first printed circuit board to the touch screen, the second printed circuit board configured to electrically connect the first printed circuit board to a main circuit board of the electronic device.

5. The electronic device as described in claim 4, wherein the second printed circuit board is a flexible printed circuit board.

6. The electronic device as described in claim 4, wherein the NFC antenna further comprises a first antenna connection element and a second antenna connection element connected to two ends of the coil, respectively; the second printed circuit board comprises a first antenna connection pin and a second antenna connection pin electrically connected to the first antenna connection element and the second antenna connection element, correspondingly.

7. The electronic device as described in claim 6, wherein the second conducting layer defines two via-holes aligned with the first antenna connection element and the second antenna connection element, correspondingly, to allow the first antenna connection element and the second antenna connection element to be electrically connected to the first antenna connection pin and the second antenna connection pin via the via-holes, correspondingly.

8. The electronic device as described in claim 7, further comprising a touch sensing circuit printed on a peripheral area of an opposite surface of the second conducting layer to the shielding layer and aligned with ineffective touch area of the touch screen.

9. The electronic device as described in claim 8, wherein the touch sensing circuit comprises a first circuit connection element, which comprises a plurality of pins; the second printed circuit board further comprises a second circuit connection element, wherein the second circuit connection element comprises a plurality of pins electrically connected to the number of pins of the first circuit connection element.

10. The electronic device as described in claim 9, further comprising a connector disposed on the second printed circuit board and electrically connected to the main circuit board of the electronic device, wherein the connector comprises a plurality of pins electrically connected to the first antenna connection pin, the second antenna connection pin, and each pin of the second circuit connection element, respectively.

11. The electronic device as described in claim 1, wherein the material of the touch screen includes carbon nanotubes.
